(19) United States
(12) Patent Application Publication
(10) Pub. No.: US 2009/0119744 A1
(43) Pub. Date: May 7, 2009

(54) DEVICE COMPONENT ROLL BACK PROTECTION SCHEME

(75) Inventors: Sebastian Lange, Seattle, WA (US); Victor Tan, Seattle, WA (US); Adam G. Poulos, Bothell, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/016,940

(22) Filed: Jan. 18, 2008

Related U.S. Application Data
(60) Provisional application No. 60/984,693, filed on Nov. 1, 2007.

(51) Int. Cl. G06F 21/00; G06F 12/14

(52) U.S. Cl. 726/1; 713/189

(57) ABSTRACT

Various embodiments of the present disclosure describe techniques for enforcing a subcomponent related security policy for closed computing systems. A closed computing system can include a list of subcomponents that identify the subcomponents it was manufactured with. The list can be used to determine if any currently attached subcomponents are different than the original ones. If a new subcomponent is detected, the device can perform a predetermined action in accordance with a security policy.

### CROSS-REFERENCE TO RELATED APPLICATIONS

This application claims priority to Application No. 60/984,693 filed Nov. 1, 2007 (Attorney docket number MSFT-6009), the contents of which are herein incorporated by reference in their entirety

### BACKGROUND

In closed computing systems such as cellular phones, set-top boxes, videogame consoles, MP3 players, home theater equipment, and the like, the subcomponents used to create the computing system tend to go through various revisions. For example, a first batch of cellular phones produced by a company may include cellular transceivers manufactured by a specific subcontractor. At some point later, the company may switch subcontractors and place their transceivers in the next version of the cellular phone. In other situations, the company may discover that certain subcomponents are vulnerable to certain types of exploits, e.g., a user may discover that by placing a piece of felt cloth on a certain portion of a device's main board they can circumvent a security measure, or a user may discover that by holding down the shift key on a keyboard while playing a DVD or CD prevents a DRM program from running. While security flaws in software can be patched, it is more difficult to fix security flaws in hardware since doing so would require that the devices be recalled or, new parts be shipped to the owners.

In the case of hardware, instead of recalling all the devices that have susceptible subcomponents, the company could stop using the subcomponents and only sell devices with new subcomponents. In this situation however, the flawed subcomponents may still be available on the secondary market, and an owner could purchase a new device and replace the new subcomponents with the susceptible ones. This is compounded by the fact that newer versions of the devices may introduce other subcomponents, features, or services, that rely on the security offered by the new subcomponents. If an attacker is able to place a susceptible subcomponent in a device, they may be able to obtain services that they are not authorized to receive.

### SUMMARY

In an example embodiment of the present disclosure, a computer readable storage medium is provided that includes, but is not limited to, instructions for determining whether a subcomponent currently attached to a device is listed in a subcomponent list that includes identification information for a subcomponent attached to the device during a manufacturing process; and instructions for performing an action in accordance with a security policy in response to the determination. In addition to the foregoing, other aspects are described in the claims, drawings, and text forming a part of the present disclosure.

In an example embodiment of the present disclosure, a closed computing device is provided that includes, but is not limited to, at least one subcomponent operatively coupled to a main board of the device; and a protected memory location integrated with the main board that includes a subcomponent list and an encrypted hash of information in the subcomponent list, wherein the information in the subcomponent list includes identification information for a subcomponent attached to the main board during a manufacturing process. In addition to the foregoing, other aspects are described in the claims, drawings, and text forming a part of the present disclosure.

In an example embodiment of the present disclosure, a method is provided for enabling the enforcement of a hardware based policy that includes, but is not limited to, receiving, from a device, information related to a plurality of subcomponents in the device and a device identifier associated with the device; generating a hash of the information related to the plurality of subcomponents in the device and the device identifier associated with the device; encrypting the hash using a private encryption key; and transmitting, to the device, the encrypted hash. In addition to the foregoing, other aspects are described in the claims, drawings, and text forming a part of the present disclosure.

It can be appreciated by one of skill in the art that one or more various aspects of the disclosure may include but are not limited to circuitry and/or programming for effecting the herein-referenced techniques; the circuitry and/or programming can be virtually any combination of hardware, software, and/or firmware configured to effect the herein-referenced techniques depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example computer system wherein aspects of the present disclosure can be implemented.

FIG. 2 depicts an example manufacturing environment wherein aspects of the present disclosure can be implemented.

FIG. 3 depicts an example operational environment wherein aspects of the present disclosure can be implemented.

FIG. 4 depicts operational procedures relating to enforcing a hardware based policy.

FIG. 5 depicts operational procedures relating to enforcing a hardware based policy.

### DETAILED DESCRIPTION OF ILLUSTRATIVE EMBODIMENTS

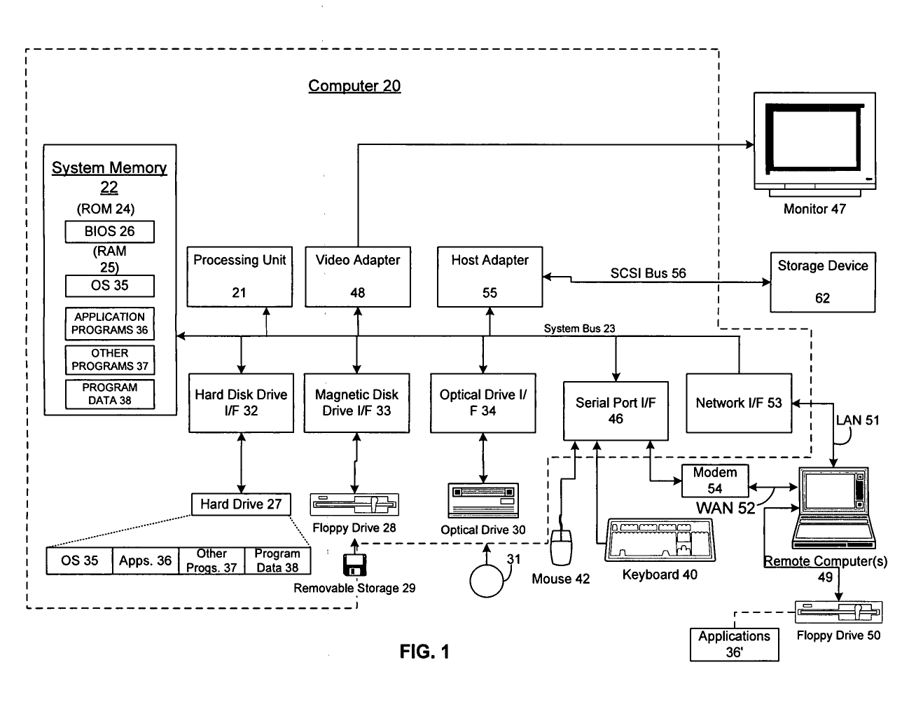

Numerous embodiments of the present disclosure may execute on a computer. FIG. 1 and the following discussion is intended to provide a brief general description of a suitable computing environment in which the disclosure may be implemented. Although not required, the disclosure will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the disclosure may be practiced with other computer system configurations, including hand held devices, multi processor systems, microprocessor based or programmable consumer electronics, network PCs, minicomputers, mainframe computers and the like. The disclosure may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

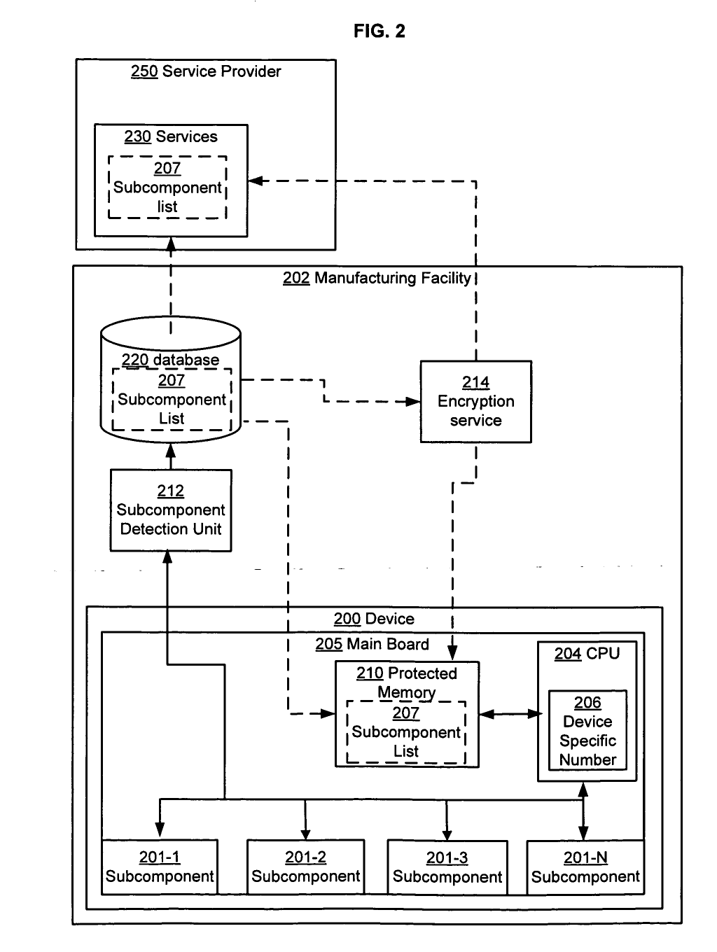

Referring now to FIG. 2, it depicts an example manufacturing environment that can be used to practice aspects of the present disclosure. One skilled in the art will note that the example elements depicted in FIG. 2 are provided to illustrate an example operational context that is to be treated as illustrative only and in no way limit the scope of the claims.

As illustrated by FIG. 2, it depicts a manufacturing facility 202 that can be coupled to a service provider 250 via a network such as the Internet. In some embodiments of the present disclosure, the manufacturing facility 202 can be a company that creates a device 200 to work in an ecosystem maintained by a service provider 250. For example, in some example embodiments the manufacturing facility 202 can manufacture a device 200 such as a cellular phone, a set-top box, a VCR, a DVD player, a videogame console, or any other closed computing device that include components similar to those of computer 20 of FIG. 1.

As briefly described above, the manufacturing facility 202 in some instances can be coupled to a service provider 250 that can offer one or more services identified as services 230. These services 230 can in some instances be cellular phone services, data plans operable to allow a device to connect to a network such as the Internet, music downloads, movie downloads, ring tone downloads, picture downloads, videogame downloads, online videogame playing, premium channels, etc. In a specific example where the service provider 250 is a cellular phone carrier, the service provider 250 may offer services such as digital voice plans, packet based data plans, or text message plans. In another specific example where the service provider 250 is a media distributing entity, the services 230 may include online videogame services, movie download services, music download services, or any other multi-media services. While in some embodiments it is contemplated that the service provider 250 may control the manufacturing facility 202, and/or one or more of services 230, in at least one example embodiment the manufacturing facility 202 can be associated with the service provider 250.

Continuing with the description of FIG. 2, it illustrates elements of a manufacturing facility 202 that can be used to effect aspects of the present disclosure. The manufacturing facility 202 can generally include industrial equipment necessary to create closed computing devices such as device 200. In some instances the manufacturing facility 202 may assemble parts obtained from various original equipment manufacturers, or in other embodiments the manufacturing facility 202 may manufacturer their own parts. During the assembly process, the device 200 can be fitted with a main board 205 and other parts can be attached to, or integrated with, the main board 205. More specifically, the manufacturing facility 202 can include equipment operable to assemble the device 200 by attaching subcomponents such as subcomponents 201-1 through 201-N where N is an integer greater than 1 to the main board 205. In some example embodiments of the present disclosure, subcomponents 201-1 through 201-N can include, but are not limited to, optical disk drives similar to optical disk drive 30 of FIG. 1, hard disk drives similar to hard disk drive 27 of FIG. 1, system memory similar to system memory 22 of FIG. 1, video adapters similar to video adapter 48 of FIG. 1, etc. In some embodiments, a part connected to the main board 205 can be considered a subcomponent if it has a low level of permanence, i.e., if it can be easily removed from the main board 205 without damaging the device 200. In an illustrative example, if a user were to open up a general purpose computer system, they could discover that parts are attached to the main board at various levels of permanence, i.e., certain parts could be easily removed by disconnecting wires, and using a screw driver. In a general purpose computer example, a stick of RAM, a hard drive, a disk drive, an optical disk drive, a power supply, or even a CPU could be considered to have low levels of permanence, because they can be removed by a user with little difficulty, whereas a transistor soldered to the main board could be considered to have a high level of permanence since it has been physically integrated with the main board and is not easily removed without damaging the computer.

In addition to attaching subcomponents 201-1 through 201-N to the main board 205, the manufacturing facility 202 can integrate zero or more additional components with the main board 205 in a more permanent manner than subcomponents 201-1 through 201-N. For example, and as shown by FIG. 2, in one embodiment protected memory 210 and CPU 204 can be integrated with the main board 205. While the depicted example context illustrates CPU 204 and protected memory 210 as integrated with the main board 205 other embodiments exist where CPU 204 and protected memory 210 are themselves subcomponents, and the disclosure is not limited to the depicted example context, i.e., in some example embodiments the CPU 204 and/or the protected memory location 210 may have a low level of permanence such as in a general purpose computer.

In some instances of the present disclosure, the protected memory location 210 can be effected by a region of memory such as read only memory, random access memory, flash memory, EPROM, EEPROM, or the like. In some example embodiments, the protected memory 210 can be an area of memory that is reserved by the device 200 to store sensitive information, and thus, may not be normally accessible to the user during the operation of device 200. In a more specific example, the protected memory region 210 can be reserved and may not be accessible to user space processes or threads. Protected memory 210 can in some embodiments of the present disclosure be considered protected because a manufacturing facility 202 has manufactured the device 200 so that the contents will be kept hidden from the user during a normal operating procedure. The service provider 250 may want this information to be kept hidden because, for example, the contents of the protected memory location 210 can be used to differentiate between devices connected to the ecosystem. For example, each device can include unique information in order for them to be distinguished by the service provider 250. If this information was easily discovered, e.g., if it was in plain text in a file or written on the side of the device 200, an attacker may be able to modify the information and assume the identity of a different device, e.g., a device that has access to more, or other services. In some embodiments, this information can include the device ID of the device 200, e.g., an identifier that the device uses when connecting to services 230 such as those offered by service provider 250. In another embodiments, one or more public or private keys used to unlock services 230 such as those offered by the service provider 250 can be stored in a protected memory location 210, e.g., the protected memory 210 can include information that would permit the device 200 to connect and interact with services 230 that the service provider 250 can charge fees for.

Continuing with the description of FIG. 2, once subcomponents 201-1 through 201-N are attached to the main board 205 of the device 200, a subcomponent detection unit 212 can be coupled to the device 200 in order to obtain information about the subcomponents 201-1 through 201-N attached to the main board 205 of device 200. For example, the subcomponent detection unit 212 can include components similar to those in computer 20 of FIG. 1, and a program that can be executed to identify each subcomponent 201-1 through 201-N connected to the main board 205. More specifically, subcomponent detection unit 212 can include any hardware, software, or a combination thereof necessary to transmit a request to a device 200 for information about its subcomponents 201-1 through 201-N; and receive any subcomponent information from the device 200. As illustrated by FIG. 2, this information can be subsequently stored in a database 220 where the information can be associated with information such as the device ID of the device 200. In an example embodiment, the subcomponent detection unit 212 can be configured to interface with an API of the device 200 that can be exposed while the device 200 is located at the manufacturing facility 202. The API can be configured to allow the subcomponent detection unit 212 to query the subcomponents in the device 200 for their identification information, and the subcomponents 201-1-201-N, can be configured to transmit identification information back to the subcomponent detection unit 212. Generally speaking, the subcomponents 201-1-201-N can reply to the query with identification information that can be used to determine what parts the subcomponents 201-1-201-N are, e.g., a reply could identify that a hard drive, Ethernet card, and/or an optical disk drive, are currently connected to the main board 205. In some instances, the identification information obtained from the subcomponents 201-1 through 201-N can be more specific and can include model numbers of the subcomponents 201-1-201-N, version numbers of hardware in the subcomponents 201-1-201-N, version numbers of the firmware in the subcomponents 201-1-201-N, serial numbers of the subcomponents 201-1-201-N, the names of the subcontractors that manufactured the subcomponent 201-1-201-N, etc. In some embodiments, each subcomponent 201-1 through 201-N can have this information stored in smart chips, or ROM integrated with the subcomponents 201-1 through 201-N.

Continuing with the description of FIG. 2, once the subcomponent detection unit 212 records identification information for the subcomponents 201-1-201-N, it can transmit this information to a database 220 where it can be saved in a subcomponent list 207. In some embodiments of the present disclosure the database 220 can include a relational database, an object oriented database, and/or column oriented database, running on a computer system that can have similar components as those of computer 20 in FIG. 1. The information can be recalled and perceived based on the type of database management system used to access the data. For example, a relational database oriented view can depict a row including the device identifier of device 200 and multiple columns, each column could be associated with a subcomponent and could store information such as the subcomponent's version number, etc. The subcomponent list 207 in some embodiments could be a list that includes information about at least one subcomponent 201-1 through 201-N that was attached to the main board 205 of a device 200 during the manufacturing process and identification information for the at least one subcomponent 201-1 through 201-N.

Once the subcomponent list 207 is saved in a database 220, the manufacturing facility 202 has multiple options as illustrated by the dashed lines of FIG. 2. These dashed lines represent different choices that the manufacturer can make depending on how secure the manufacturing facility 202 wants to make the subcomponent list 207. If, for example, the manufacturing facility 202 only wants to rely on the protection offered by the device 200, the manufacturing facility 202 can transmit a plain text copy of the subcomponent list 207 to the device 200, and the device 200 can save the subcomponent list 207 in protected memory 210. In an example embodiment, once the plain text copy of the subcomponent list 207 is stored in protected memory 210, the protected memory location 210 can be encrypted by a device specific number 206 that in some embodiments be a symmetric or public/private key using techniques that will be described in more detail below. In the same, or another embodiment, if the manufacturing facility 202 is not worried about the integrity of data maintained by the service provider 250, it can additionally transmit a plain text copy of the subcomponent list 207 to the services 230.

As indicated by the dashed lines, an encryption service 214 in some instances can be used to protect the information in the subcomponent list 207 by either encrypting the subcomponent list 207, or a hash of the subcomponent list 207. For example, a computer system similar to computer 20 described above with respect to FIG. 1 can include a program that includes a key generation algorithm and can be used to create public decryption and private encryption key pairs for example. In one implementation, the encryption service 214 can use a cryptographic hash function such as SHA-1 to generate a hash of the subcomponent list 207. The hash of the subcomponent list can then be encrypted by the encryption service 214 using a private encryption key. In some embodiments, the private encryption key could be used to encrypt the hash on multiple devices, or in other embodiments each hash of each device could be encrypted with a unique private encryption key. The private key in some example embodiments can then either be deleted or stored in a database maintained by the manufacturing facility 202. The encrypted hash of the subcomponent list 207 can be embedded in the subcomponent list 207 and transmitted to the protected memory 210 where it can then be stored, or it can transmitted to the device 200 and embedded in the protected memory location 210 along with the subcomponent list 207. In example embodiments using an encrypted hash of the information in the subcomponent list 207, it may be difficult to change any of the subcomponents 201-1 through 201-N without breaking the hash. For example, if an attacker changes a subcomponent such as subcomponent 201-1 to subcomponent 201-1′, e.g., to a subcomponent that is susceptible to an exploit, and the attacker is able to modify the subcomponent list 207 stored in protected memory 210 to include subcomponent 201-1′, then the hash of the modified subcomponent list would be different than the embedded encrypted hash. In this example, the device 200 could be configured to discover the change and perform an action. By encrypting the hash during the manufacturing process, the service provider 250 guarantees that there is only a single place and single time where an authentic hash of a subcomponent list 207 can be made.

In some embodiments an encryption service 214 can include a cryptographic function that can be used to encrypt the subcomponent list 207 and then the encrypted subcomponent list can be transmitted to the device 200. In this example, the encryption service 214 can place the device specific number 206 in the subcomponent list 207 and encrypt it along with the subcomponent information. This subcomponent list 207 can then be transmitted to the device 200 where it can be saved in protected memory 210. In this example, the device 200 can be configured to include a public decryption key and a cryptographic algorithm that can be used by the CPU 204 to decrypt the subcomponent list 207 if the information is desired. The code that effects the decryption process can be configured to be processed by the CPU 204 and the device specific number 206 stored in the subcomponent list 207 can be compared to the device specific number 206 stored in the CPU 204 for example. If the device specific number 206 matches the one stored in the device 200, then the CPU 204 could be configured to determine that the subcomponent list 207 has not been tampered with. By encrypting the subcomponent list 207 during the manufacturing process, the service provider 250 guarantees that there is only a single place and single time where an authentic subcomponent list can be made, and by including the device specific number 206 in the subcomponent list 207 a strong tie is created between the subcomponent list 207 and the device 200.

In embodiments where the subcomponent list 207 is stored in protected memory 210, the manufacturing facility 202 can in some embodiments use a device specific number 206 stored in the CPU 204 to encrypt the contents of the protected memory 210. For example, when device 200 is manufactured, a computer program executing on a computer maintained by the manufacturing facility 202 can select a number from a device specific number database and store it in the device 200. In this example embodiment, a cryptographic key generating function can be used to create a device specific number 206. In these embodiments, the device specific number 206 could be a symmetric key, e.g., a key that can be used to encrypt and decrypt information, or it could be an public decryption key of a public/private key pair. In the example embodiment where the device specific number is a public decryption key, the protected memory location 210 could be decrypted, however the device 200 could be configured to not include any means for encrypting the protected memory location 210. In this example it would be difficult for an attacker to decrypt the contents of the protected memory and re-encrypt it. As illustrated by FIG. 2, in some instances the device specific number 206 can be stored in the CPU 204 or in other embodiments it could be stored in another location on the main board 205 (not illustrated). For example, in some example embodiments of the present disclosure, the device specific number 206 can be stored in the device 200 by directing a computer system to burn the number into the CPU 204 or into the main board 205 using one time writable storage. In this example embodiment, the device specific number 206 would be hardwired into the device 200 and it would not be easy to modify it without damaging the device 200. In this example, the device specific number 206 could be used as a root of trust for processes that determine whether the device 200 is authorized to access services 230 since it is difficult to modify the number. In other embodiments of the present disclosure, the computer program executing on a computer that generates the device specific number 206 can store, e.g., transmit, a device specific number 206 to the device 200 to flash memory, EEPROM, or EPROM memory, etc. In these example embodiments it is less likely that the device specific number 206 would not be modified, e.g., flash containing the number could be removed and replaced.

As illustrated by FIG. 2, in an embodiment an encrypted or unencrypted subcomponent list can be transmitted to the service provider 250 and made accessible to services 230. In this example, when a device 200 attempts to connect to a service, the service can be configured to challenge the device 200 by requesting information about the subcomponents currently attached to the device 200. In other example embodiments, the device 200 can be configured to download an encrypted, or unencrypted subcomponent list from the service provider 250 at predetermined intervals such as when the device 200 is turned on, when it is connected to the service provider 250, once a day, etc. In this example, the device 200 can use the received subcomponent list 207 to verify that its subcomponents 201-1 through 201-N have not been modified.

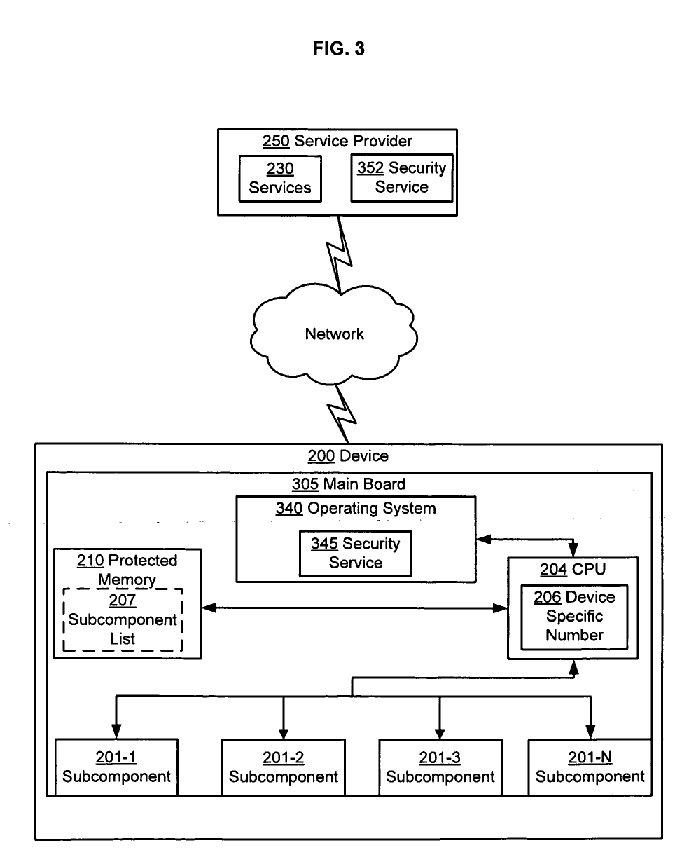

Referring now to FIG. 3, it depicts a device 200 that can be operating in the field, e.g., at a customer's location. As illustrated by FIG. 3, the device 200 can include an operating system 340 that includes a security service 345. For example, in some embodiments an operating system 340 can be loaded onto a hard drive of the device 200. The operating system 340, can include code that when executed by a CPU 204 can manage the hardware of the device 200. In some example embodiments the operating system 340 code can include code for a security service 345, e.g., a program that can include code operable to receive requests for information in the protected memory location 210 from a thread or process running in kernel or user space to obtain information from the protected memory location 210, and determine if the contents of the protected memory location 210 have been modified.

Continuing with the description of FIG. 3, it additionally depicts a service provider 250 that includes a security service 352. For example in some embodiments of the present disclosure the service provider 250 can include either an encrypted or unencrypted subcomponent list 207 that identifies the subcomponents 201-1 through 201-N that device 200 was manufactured with. In certain embodiments of the present disclosure, the security service 352 can include a program that when executed can determine whether the subcomponents 201-1 through 201-N in device 200 have been modified.

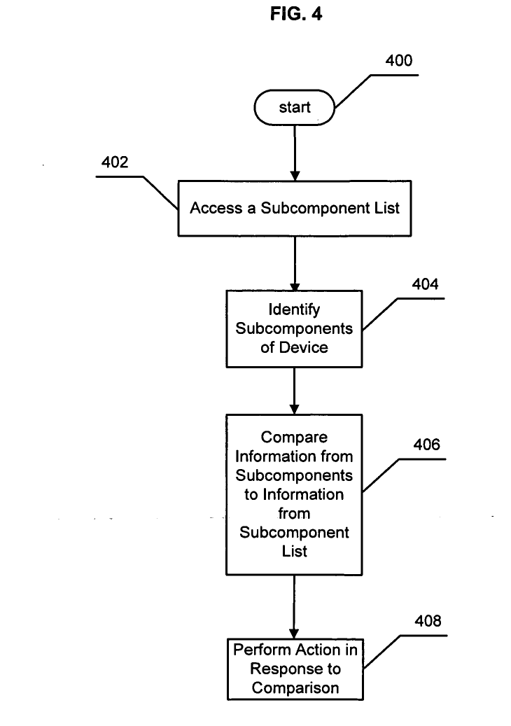

Referring now to FIG. 4 in conjunction with FIG. 3, it provides an operational flow chart illustrating aspects of the present disclosure. As shown by operation 400 of FIG. 4, the operational procedure can begin when predetermined criteria occur. For example, in some embodiments of the present disclosure, the service provider 250 can receive a request from device 200. In this example, the request could be to access a service such as a online videogame playing service that allows a user of the device 200 to play other users in an online game. In another example, the operational process 400 can be initiated once a day, week , or month. For example, once a week the device 200 can be configured to transmit a signal to the service provider 250 that enables the service provider 250 to locate the device 200 in a the wide area network such as the Internet. The service provider 250 in this example can start the operational process after the device 200 is located.

As illustrated by operation 402. In some example embodiments when the operational process 400 is initiated, the security service 352 can obtain a subcomponent list 207 that is associated with the device 200 from a database. For example, each device may include a device identifier that is transmitted to the service provider 250 in some, or all of the signals sent from the device 200. In this example, the security service 352 could use the device identifier of the device 200 to find the associated subcomponent list 207. In one example embodiment, the service provider 250 can then transmit one or more packets of information indicative of a subcomponent list 207 encrypted with a private encryption key, and a request directing the device 200 to determine whether the current subcomponents match the subcomponents in the received subcomponent list 207. A network adaptor of the device 200 can receive the request, and the operating system 340 can load the code effecting the security service 345. The security service 345 can receive the encrypted subcomponent list 207 and run a decryption algorithm using a public decryption key to decrypt the received subcomponent list 207.

In another embodiment, the service provider 250 could transmit a request to the device 200 for information about the subcomponents 201-1 through 201-N currently attached to the main board 205 of the device 200. The device 200 could receive the request and a process or thread of the security service 345 of the device 200 can be configured to identify the subcomponents 201-1 through 201-N currently connected to the main board 205 of the device 200. As described above and referring to operation 404, the subcomponents 201-1 through 201-N can transmit their information back to the security service 345 such as model numbers, version numbers of hardware, version numbers of the firmware, serial numbers, the names of the subcontractors that manufactured the subcomponents 201-1-201-N, etc., placed in a smart chip, or read only memory of the subcomponents 201-1 through 201-N. The security service 345 can use the Ethernet adaptor to transmit the information back to the service provider 250.

Continuing with the description of FIG. 4, once the security service 352 receives the information about the subcomponents 201-1 through 201-N, the security service 352 can be configured to use a process operable to compare the identification information from the subcomponents 201-1 through 201-N currently attached to the main board 205 to the identification information in the subcomponent list 207. If there is a discrepancy between the information related to the current subcomponents 201-1 through 201-N and the information in the subcomponent list 207, e.g., some of the information received from the currently attached subcomponents 201-1 through 201-N is different than information in the list subcomponent 207, then as shown by operation 408 security service 352 can be configured to perform an action.

For example, in some instances the security service 352 can take an action in accordance with a policy. The action can be as flexible as the service provider 250 or manufacturing facility 202 specifies. In some instances, the action can involve ending the process without taking any action. More specifically, in some embodiments of the present disclosure, the security service 352 can allow the device 200 to operate without interrupting any functions. A service provider 250 may be interested in using this type of configuration for devices that were manufactured before a predetermined date or any other business related reasons. In another example embodiment, the security policy could direct the security service 352 to disable the device 200 if a slight change is detected, e.g., change in serial number, or change to the firmware version number.

Various intermediate levels of security can also be encoded in a security policy and can be changed by the service provider 250 throughout the life cycle of the device 200. For example, in one embodiment of the present disclosure, the service provider 250 can identify subcomponents that are susceptible to certain exploits and maintain a database of such information. The service provider 250 can create a list of susceptible subcomponents and the security service 352 can be configured to check the subcomponents in subcomponent list 207 associated with the device 200 to determine whether any of the susceptible subcomponents were placed in the device 200 during the manufacturing process. If any were, the service provider 250 can transmit a signal to the device 200 directing it to refuse to run certain code that is related to the exploit. For example, if the exploit was related to recording high definition content on a subcomponent such as an optical disk drive, the code that runs the high definition media player on the device 200 can be disabled by the service provider 250. In another instance, the security service 352 can be configured to deny connections to any of services 230 that offer a service that can be exploited by the susceptible subcomponent, e.g., the security service 352 could be configured to deny connections to any device 200 that includes an optical disk drive that is susceptible to an exploit.

In another example, the service provider 250 can include a list of permissive upgrades. The security service 352 can receive information identifying the subcomponents 201-1 through 201-N that are currently connected to the main board 205 of the device 200. If the subcomponents are different, the security service 352 can check to see if any of the subcomponents added after the manufacturing process are listed on the list of permissive upgrades. If the subcomponents are on the list, then the security service 352 can be configured to allow the device 200 to operate. In some example embodiments the permissive upgrade list can include newly manufactured components that are not susceptible to known exploits. The information in the upgrade list can include serial numbers of permissive subcomponents, hardware version numbers of permissive subcomponents, firmware version numbers of permissive subcomponents, acceptable manufacturers of permissive subcomponents, etc.

In some embodiments of the present disclosure, the security policies can include information identifying when a difference between the subcomponent list 207 and the subcomponents installed on the main board 205 is acceptable. For example, the security policy can direct a security service 352 to enforce a strict policy until a warranty period for the device 200 elapses. In this example, if the user modifies the subcomponents on the device 200 before the warranty period elapses the device 200, the service provider 250 can be configured to send a signal to the device 200 that can direct it to shut down, or perform an action described above. In this example, after the warranty period ends, the security service 352 can be configured to allow the user to modify any of the subcomponents, or allow them to modify the subcomponents in accordance with a list of permissive upgrades.

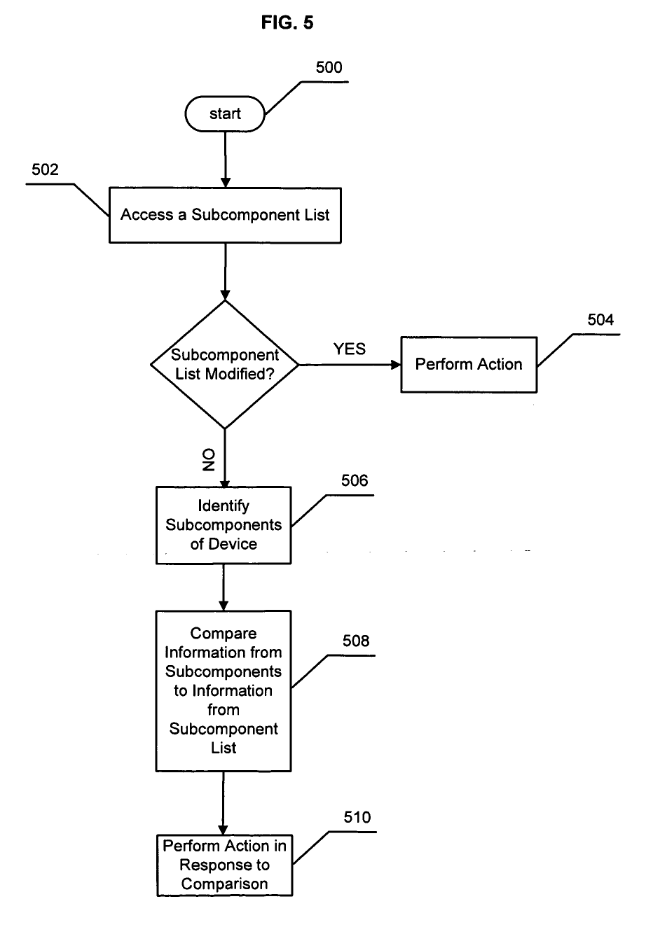

Referring now to FIG. 5 in conjunction with FIG. 3, it depicts operational procedures relating to enforcing a hardware based policy. Operation 500 begins the operational procedure and in some instances the operational procedure 500 can be configured to initiate after the device 200 is powered on by the user. In this embodiment, the device 200 could be configured to include a subcomponent list 207 in protected memory 210 as illustrated in FIG. 3. When a bootstrapping program is loaded from memory to start up the system, the security service 345 can be executed. In another embodiment, the security service 345 can be configured to initiate the operational procedure 500 when the functionality of a specific subcomponent is requested by an application running in user, or kernel space. For example, a user may insert a disk into an optical disk drive subcomponent and this can initiate the operational procedure 500. More specifically, when a disk is inserted into a the disk drive subcomponent, the security service 345 can be configured to check the entire subcomponent list 207 to see if any components were modified, or it can check to see if the subcomponent being utilized has been modified.

In an example embodiment, certain user input could trigger the security service 345 to determine whether any of the subcomponents were modified such as if the user attempts to connect device 200 to services 230 offered by service provider 250. In this example, the service provider 250 may want to guarantee that every device 200 that connects to services 230 is checked to see if their subcomponents 201-1 through 201-N have been modified before they are allowed to access the services 230. In yet another example embodiment, the operational procedure 500 can be initiated at predetermined intervals by the device 200. For example, a device 200 can include a clock and the operating system 340 can be configured to call the security service 345 every hour, once a day, etc.

Continuing with the description of the operational procedure of FIG. 5, after predetermined criteria occur, and the operational process 500 is initiated, the device 200 can perform one or more operations or procedures to access a subcomponent list 207 that can be stored in protected memory 210 as shown by operation 502. In an example embodiment of the present disclosure, a subcomponent list 207 can be stored at the service provider 250. The service provider 250 in this example can transmit one or more packets of information indicative of a subcomponent list 207 encrypted with a private encryption key, and a request directing the device 200 to determine whether the current subcomponents match the subcomponents in the received subcomponent list 207. A network adaptor of the device 200 can receive the request, and the operating system 340 can load the code effecting the security service 345. The security service 345 can receive the encrypted subcomponent list 207 and run a decryption algorithm using a public decryption key to decrypt the received subcomponent list 207.

In an alternative embodiment, the service provider 250 can transmit a copy of the subcomponent list 207 that includes a hash of the information in the subcomponent list encrypted with the private encryption key held by the manufacturing facility 202 for example. An Ethernet adaptor of the device 200 can receive the request, and the operating system 340 can load the code effecting the security service 345. The security service 345 can receive the encrypted hash of the subcomponent list 207 and run a decryption algorithm using a public decryption key to decrypt it.

In yet another alternative embodiment, a copy of the subcomponent list 207 can be stored in the protected memory location 210 during the manufacturing process. In this example embodiment, when predetermined criteria occur the operating system 340 can be configured to call the security service 345 by loading the code effecting the security service 345 into memory. The security service 345 can access the protected memory 210 and obtain a copy of the subcomponent list 207.

In some example embodiments prior to obtaining a subcomponent list 207 from protected memory 210 the security service 345 can be configured to decrypt the contents of the protected memory location 210. For example, in some embodiments the protected memory location 210 can be over encrypted with a device specific number 206. In these example embodiments, the code that effects the security service 345 can be processed by the CPU 204 and the device specific number 207 can be used it to decrypt the protected memory location 210. In one example, the device specific number 207 can be a public decryption key and the protected memory location 210 could have previously been asymmetrically encrypted with a private encryption key that could be either held by the manufacturing facility 202, or destroyed. The security service 345 can be configured to check to see if the protected memory location 210 is encrypted, and if it was the CPU 204 can be configured to decrypt it otherwise the security service 345 can determine that the protected memory location 210 has been modified and refuse to operate. In other embodiments of the present disclosure, the device specific number 207 can be a symmetric encryption key. In this example embodiment, the code that effects the security service 345 can be processed by the CPU 204 and the CPU 204 can use the symmetric key to decrypt the protected memory location 210.

Continuing with the description of FIG. 5, once the subcomponent list 207 is obtained; the security service 345 can be configured to determine if the subcomponent list 207 has been modified. In one example embodiment the subcomponent list 207 can include an asymmetrically encrypted hash of the subcomponent list 207 that the device 200 was manufactured with. In this example, the security service 345 can be configured to use a decryption algorithm and a public decryption key to decrypt the hash. The security service 345 can then use a hash generating function to calculate a hash of the information currently in the subcomponent list 207. After the hash is calculated, the security service 345 can compare the hash value to the decrypted hash embedded in the subcomponent list 207. In the instance that they match, the security service 345 can be configured to determine that the subcomponent list 207 has not been modified. In the instance that hash values do not match, the security service 345 can perform an action that will be described in more detail below.

In an example embodiment, one in which the subcomponent list 207 was asymmetrically encrypted and stored in protected memory 210, the security service 345 can be configured to determine if the subcomponent list 207 had been modified. In this example, the security service 345 can be configured to use a decryption algorithm and a public decryption key to decrypt the subcomponent list 207. In this example, the subcomponent list 207 could have been configured to include the device specific number 206. The security service 345 can be configured to compare the device specific number 206 stored in the subcomponent list 207 to the device specific number 206 stored on the main board 205 or CPU 204. In the instance that they match, the security service 345 can be configured to determine that the subcomponent list 207 has not been modified. In the instance that the device specific numbers do not match, the security service 345 can perform an action that will be described in more detail below.

In yet another embodiment, a subcomponent list 207 that includes a device specific number 206, a hash of a subcomponent list 207, or a hash of the subcomponent list 207 that includes a device specific number 206 can be encrypted by a service provider 250 with a public encryption key and transmitted to device 200 via a network such as the Internet. An Ethernet adaptor can receive the encrypted subcomponent list 207 and the security service 345 can use a private decryption key and a decryption algorithm to decrypt the received subcomponent list 207. In some embodiments where the information received from the service provider 250 includes the device specific number 206, the security service 345 can be configured to compare the current device specific number 206 to the one received from the service provider 250. In the instance that the device specific numbers do not match, the security service 345 can perform an action that will be described in more detail below.

Continuing with the description of FIG. 5, as shown by operation 504, if the security service 345 determines that the subcomponent list 207 has been modified, or the device specific number 206 has been tampered with, then the security service 345 can access code that directs the device 200 to perform an action. For example, in some embodiments of the present disclosure, if the security service 345 determines that it has been modified, it can simply shut down the device 200 and a bit can be set in hardware that configures the device 200 to refuse to load the operating system 340. In another example, the operating system 340 can be configured to transmit one or more packets of information to the service provider 250 that indicates that the device 200 has been compromised. In this example, the service provider 250 can ban the device identifier associated with the device for example. In yet another example, a bit can be set in hardware that identifies to the operating system 340 that directs the operating system 340 to refuse to connect to any services such as services such as services 230. In this example, a modified device can still be used by the user, however it will not be able to access the ecosystem maintained by the service provider 250.

Continuing with the description of FIG. 5, and referring to operation 506, if the security service 345 determines that the subcomponent list 207 has not been modified, a process or thread of the security service 345 can be configured to identify the subcomponents 201-1 through 201-N currently connected to the main board 205 of the device 200. As described above, the subcomponents 201-1 through 201-N can include information such as model numbers, version numbers of hardware, version numbers of the firmware, serial numbers, the names of the subcontractors that manufactured the subcomponent 201-1-201-N, etc., placed in a smart chip, or read only memory of the subcomponents 201-1 through 201-N. The subcomponents 201-1 through 201-N can receive the request from the security service 345 for their information and reply with the information stored in ROM or smart chips.

After the subcomponents 201-1 through 201-N have replied with their identification information, and as shown by operation 408 the security service 345 can be configured to use a process operable to compare the identification information from the subcomponents currently attached to the main board 205 to the identification information in the subcomponent list 207. If there is a discrepancy between the information the current subcomponents have returned and the information in the subcomponent list 207, e.g., some of the information received from the currently attached subcomponents is different than information in the subcomponent list 207, then as shown by operation 410 a security service 345 can take be configured to perform a predetermined action.

For example, in some instances the security service 345 can take a predetermined action in accordance with a policy it has received from the manufacturing facility 202 when it was created, or a policy received from a service provider 250. The action can be as flexible as the service provider 250 or manufacturing facility 202 specifies. In some instances, the predetermined action can involve ending the process without taking any action. More specifically, in some embodiments of the present disclosure, the security service 345 can allow the device 200 to operate without interrupting any functions. A service provider 250 may be interested in using this type of configuration for devices that were manufactured before a predetermined date or any other business related reasons. In another example embodiment, the security policy could direct the security service 345 to disable the device 200 if a slight change is detected, e.g., change in serial number, or change to the firmware version number.

Various intermediate levels of security can also be encoded in a security policy and can be changed by the service provider 250 through out the life cycle of the device 200. For example, in one embodiment of the present disclosure, the service provider 250 can identify subcomponents that are susceptible to certain exploits and maintain a database of such information. The service provider 250 can create a list of susceptible subcomponents and transmit the list to the device 200. The security service 345 can be configured to check the subcomponent list 207 stored in the device 200 to determine whether any of the susceptible subcomponents were placed in the device 200 during the manufacturing process. If any were, the device 200 can refuse to run certain code on the device that is related to the exploit. For example, if the exploit was related to recording high definition content on a subcomponent such as an optical disk drive, the code that runs the high definition media player on the device 200 can be disabled. In another instance, the security service 345 can be configured to not connect to any services 230 that offer a service that can be exploited by the susceptible subcomponent, e.g., in this example a service that offers high definition content would not allow the device 200 to connect with an optical disk drive that is susceptible to an exploit.

In another example, the service provider 250 can transmit a list of permissive upgrades to the device 200. The security service 345 can identify the subcomponents 200-1 through 201-N that are currently connected to the main board 205. If the subcompacts are different, the security policy can check to see if any of the subcomponents added after manufacturing are listed on the list of permissive upgrades. If the subcomponents are on the list, then the security service 345 can be configured to allow the device 200 to operate. In some example embodiments the permissive upgrade list can include newly manufactured components that are not susceptible to known exploits. The information in the upgrade list can include serial numbers of permissive subcomponents, hardware version numbers of permissive subcomponents, firmware version numbers of permissive subcomponents, acceptable manufacturers of permissive subcomponents, etc.

In some embodiments of the present disclosure, the security policies can include information identifying when a difference between the subcomponent list 207 and the subcomponents installed on the main board 205 is acceptable. For example, the security policy can direct a security service 345 to enforce a strict policy until a warranty period for the device 200 elapses. In this example, if the user modifies the subcomponents on the device 200 before the warranty period elapses the device 200 will shut down, or perform an action described above. In this example, after the warranty period ends, the security service 345 can be configured to allow the user to modify any of the subcomponents, or allow them to modify the subcomponents in accordance with a list of permissive upgrades.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A computer readable storage medium including computer readable instructions for enforcing a policy, the computer readable instructions comprising:
instructions for determining whether a subcomponent currently attached to a device is listed in a subcomponent list, wherein the subcomponent list includes identification information for a subcomponent attached to the device during a manufacturing process; and
instructions for performing an action in accordance with a security policy in response to the determination.

2. The computer readable instruction of claim 1, wherein the subcomponent list includes an encrypted hash of the information in the subcomponent list.

3. The computer readable instructions of claim 2, wherein the subcomponent list is stored in a protected memory location, the protected memory location encrypted with a key stored in a processor of the device.

4. The computer readable instruction of claim 1, wherein the subcomponent list is encrypted and is configured to be decrypted with a public decryption key stored in the device.

5. The computer readable instructions of claim 1, wherein the identification information includes information selected from a group consisting of a model number of the subcomponent, a version number of hardware in the subcomponent, a version number of firmware in the subcomponent, a serial number of the subcomponent, and a name of the manufacturer of the subcomponent.

6. The computer readable instructions of claim 1, wherein instructions for performing an action in accordance with a security policy further comprise:
instruction for disabling the device when the currently attached subcomponent is different than the subcomponent listed in the subcomponent list.

7. The computer readable instructions of claim 1, wherein instructions for performing an action in accordance with a security policy further comprise:
instructions for disabling the device when the currently attached subcomponent is included in a list of unallowable subcomponents.

8. The computer readable instructions of claim 1, further comprising:
instructions for determining whether the subcomponent currently attached to the device is listed in a subcomponent list during a pre-boot sequence.

9. The computer readable instructions of claim 1, further comprising:
instructions for determining whether the subcomponent currently attached to the device is listed in a subcomponent list when the currently attached subcomponent is used.

10. The computer readable instructions of claim 1, further comprising:
instructions for determining whether the subcomponent currently attached to the device is listed in a subcomponent list when the device connects to a remote device.

11. A closed computing device comprising:
at least one subcomponent operatively coupled to a main board of the device; and
a protected memory location integrated with the main board that includes a subcomponent list and an encrypted hash of information in the subcomponent list, wherein the information in the subcomponent list includes identification information for a subcomponent attached to the main board during a manufacturing process.

12. The closed computing device of claim 11, wherein the subcomponent list was previously transmitted to the device by a service provider.

13. The closed computing device of claim 11, wherein the subcomponent list was previously transmitted to the device by a manufacturer of the device.

14. The closed computing device of claim 11, wherein the information in the subcomponent list includes a device specific number associated with the device.

15. The closed computing device of claim 11, wherein the protected memory location is encrypted.

16. The closed computing device of claim 11, further comprising:
a processor operable to determine whether identification information for a subcomponent currently attached to the main board matches the identification information for the subcomponent attached to the main board during the manufacturing process.

17. A method for enabling the enforcement of a hardware based policy, the method comprising:
receiving, from a device, information related to a plurality of subcomponents in the device;
generating a hash of the information related to the plurality of subcomponents in the device and a device identifier associated with the device;
encrypting the hash using a private encryption key; and
transmitting, to the device, the encrypted hash.

18. The method of claim 17, wherein the information related to a plurality of subcomponents includes information selected from a group consisting of model numbers of the plurality of subcomponents, version numbers of hardware in the plurality of subcomponents, version numbers of firmware in the plurality of subcomponents, serial numbers of the plurality of subcomponents, and names of the manufacturers of the plurality of subcomponents.

19. The method of claim 17, further comprising:
transmitting, to a service provider, the information related to the plurality of subcomponents in the device and the device identifier associated with the device.

20. The method of claim 17, further comprising:
transmitting, to the device, a decryption key operable to decrypt the hash.
